(19) United States
(12) Patent Application Publication
(10) Pub. No.: US 2006/0012567 A1
(43) Pub. Date: Jan. 19, 2006

(54) MINATURE OPTICAL MOUSE AND STYLUS

(76) Inventor: Todd Sicklinger, Jersey City, NJ (US)

Correspondence Address: TODD SICKLINGER, 35 RIVER DRIVE #1111, JERSEY CITY, NJ, 07310, US

(21) Appl. No.: 10/710,464

(22) Filed: Jul. 13, 2004

(51) Int. Cl. G09G 5/08

(52) U.S. Cl. 345/157

(57) ABSTRACT

A small optical mouse that is easy to use, that provides a standard mouse like user experience, that works efficiently in combination with a keyboard, that can be used as a stylus, and that can be used on the viewing surface of a computer monitor as well as related devices and methods.

### BACKGROUND OF INVENTION

The disclosed invention is directed to the field of computer interfaces. More specifically, it pertains to devices and methods for the manipulation of a pointer or a cursor that is displayed on a computer monitor or similar device.

A mouse is a well known computer input device. It is used to control the location of a pointer on a video display connected to a computer or other similar device. The pointer location is generally controlled by moving the mouse across a surface such as a mouse pad. The motion of the mouse is translated by electronics and software into the motion of the pointer on the display device. Additionally, a mouse typically has two and sometimes three switches (mouse buttons). These switches are used to activate functions associated with the pointer location. For example, pressing the left mouse button will typically position the cursor to the location of the pointer, and pressing the right mouse button may bring up a list of options that can then be selected by positioning the pointer and pressing the left mouse button. Further, a mouse typically has a wheel mounted between the left and right mouse buttons. The wheel is used to perform functions such as scrolling.

A conventional mouse uses a tracking ball to control pointer movement. The tracking ball protrudes from the bottom surface of the mouse and it rotates as the mouse is moved across a surface. Transducers, which can be either mechanical or optical, detect the ball's rotation and generate electrical signals that represent the mouse's movement across a two dimensional surface. These electrical signals are provided to a computer that interprets them and moves the pointer on the computer's monitor in two dimensions corresponding to the mouse's movement across the surface. It is known that very small tracking balls can be used so as to make miniature mice or pen type input devices such as the ballpoint pen type input device disclosed in U.S. Pat. No. 6,633,282.

Wireless mice are also well know in the art. A wireless mouse is not directly connected to a computer. Instead, it is outfitted with a transmitter that transmits the mouse signals to a computer or other device that is outfitted with or attached to an appropriate receiver. The transmitter is generally an RF transmitter or an infrared transmitter, although other appropriate transmission means can be used.

Optical mice, which utilize optical devices to track the motion of a mouse across a surface, are also known in the art. An optical mouse uses a miniature camera to track the mouse's motion across a surface. Typically, a light source, which may be comprised of a high luminance LED, radiates light through a crystal and onto a surface. The crystal is used to direct the light at a low angle of incidence onto the surface. The image of the illuminated portion of the surface is reflected from the surface and through a lens onto an optical detector, which could be comprised of an array of complementary metal oxide semiconductor (CMOS) optical detectors or a charge-coupled device (CCD). Each pixel of the detected image is digitalized and processed by a digital signal processor (DSP). When the mouse is moved along the surface, the DSP detects the motion by comparing translations of the previous image to the then current image. Electrical signals that correspond to the mouse's movement across the surface in two dimension are then provided to a computer, which uses them to control pointer motion across the computer's video display. U.S. Pat. No. 6,501,460 provides an example of an optical mouse.

The prior art cursor control devices each have limitations that limit their utility. Trackball type mice require a smooth flat high friction surface, such as a mouse pad, to work properly. Unfortunately, computer users do not always have convenient access to a smooth flat high friction surfaces, particularly when they are traveling and using a laptop computer or PDA. Additionally, trackball type mice are susceptible to problems caused by dust and mechanical wear although optical mice work properly on a wide variety of surfaces, as long as the surface has readily detectable surface features, they can be inconvenient to use in many situations. For example when traveling on a train, a user may not have a convenient place on which to set the mouse down while the user is typing on a keyboard. Accordingly, it can be quite inefficient to switch back and forth from keyboard to mouse. Additionally, due to the relatively large size of the light source, prior art optical mice cannot be effectively mounted on a fingertip. Further, neither trackball type mice nor prior art optical mice work effectively on the viewing surface of a computer monitor. Finally, the touch pads and pointing sticks provided on laptop computers are difficult to use and they do not provide the same user experience as a mouse.

Accordingly, there is a need for a mouse type device that is easy to use, that provides a standard mouse like user experience, that works efficiently in combination with a keyboard, that can be used as a stylus, and that can be used on the viewing surface of a computer monitor. Some efforts have been made to provide some of theses needs, although none of the previous efforts have been fully successful.

Published U.S. Patent Application No. 20030174124 discloses a finger mounted mouse, which uses a roller ball mounted on a holder at the front edge of the finger tip. When the disclosed mouse is worn on a thumb, normal typing can be performed with the other fingers. However, operating the disclosed mouse requires the user to move their hand from its normal typing position. Additionally, the disclosed mouse cannot be used to provide a user experience similar to that of a standard mouse nor can it be used on a computer monitor.

U.S. Pat. Nos. 5,444,462, and 6,097,369 disclose a mouse type device that can be worn as a glove on a user's hand. The disclosed glove mouse includes micro-switches mounted next to a joint of the index finger and on opposite sides of the wrist. The switches translate up and down movement of the index finger and side to side movement of the wrist into vertical and horizontal movements, respectively, of a pointer on a computer display. Switches are provided on the other fingers to perform mouse button functions and to turn the glove mouse on and off. These buttons are activated by the thumb. However, the device cannot be used like a standard mouse, since it does not translate motion across an external surface into pointer control signals. Additionally, it requires a great deal of skill and considerable practice for the user to be able to control a cursor on a video display with any degree of accuracy. Further, the device must be manually activated prior to use and manually deactivated after use so that hand movements are not inadvertently translated into cursor movements on the screen while the user is typing.

Published U.S. Patent Application # 20030137489 discloses an optical glove mouse. However, the disclosed glove mouse does not adequately simulate traditional mouse operation. For example, the index finger cannot be used for left mouse button operation, which substantially impedes the ability of some users to perform a “double click” operation. Additionally, wheel functions such as scrolling are provided by pushing buttons, which does not provide the same intuitive feel as a wheel. Accordingly, operation of the glove mouse disclosed in U.S. Patent Application # 20030137489 will not feel natural to a user accustomed to standard mouse. Additionally, the optical motion tracking device is rather bulky and protrudes substantially from the user's fingers, since all of the circuitry, including the light source, associated with the motion tracking device is located on the user's index finger tip.

### SUMMARY OF INVENTION

The present invention provides for small optical mice that are easy to use, that provide a standard mouse like user experience, that work efficiently in combination with a keyboard, that can be used as a stylus, and that can be used on the viewing surface of a computer monitor. Each of the described embodiments disclose some or all of these features and the scope of the claimed invention includes mice and styli that combine some or all of these features in a variety of ways. Additionally, the invention includes related methods and apparatuses for interacting with computer programs and monitors.

### BRIEF DESCRIPTION OF DRAWINGS

For a more complete understanding of the nature and objectives of the present invention, reference is to be made to the following detailed description and accompanying drawings, which, though not to scale, illustrate the principles of the invention.

FIG. 1 provides two cross sectional views of the first embodiment of the present invention while the embodiment is mounted on a user's thumb and the stylus is not extended. FIG. 1A shows a side view of the embodiment with the thumb nail up and FIG. 1B shows a side view of the embodiment with the thumb nail down.

FIG. 2 provides two cross sectional views of the first embodiment of the present invention while the embodiment is mounted on a user's thumb and the stylus is extended. FIG. 2A shows a side view of the embodiment with the thumb nail up and FIG. 2B shows a side view of the embodiment with the thumb nail down.

FIG. 3 provides a cross sectional view of the first embodiment of the present invention while the embodiment is mounted on a user's thumb. The view is shown looking down onto the thumb while the thumb nail is down. FIG. 3A shows the view with the stylus in its non-extended position. FIG. 3b shows the view with the stylus in its extended position after the mouse body has been rotated in a counterclockwise direction.

FIG. 4 is a close up cross sectional view of optical motion detector 40 of the first embodiment.

FIG. 5 provides a cross sectional view of an image fiber 61, which is part of image bundle 60.

FIG. 6 is a functional block diagram showing remote housing 50 of the first embodiment.

FIG. 7 is a diagram showing the second embodiment of the present invention.

FIG. 8 is a close up cross sectional view of motion detector 120 of the second embodiment.

FIG. 9 is a functional block diagram showing housing 140 of the second embodiment of the present invention.

FIG. 10 provides two views of the third embodiment of the present invention. FIG. 10A is a top view and FIG. 10B is a bottom view.

FIG. 11 is a functional block diagram showing glove mounted housing 220 of the third embodiment of the present invention.

FIG. 12 is a functional block diagram showing the fourth embodiment of the present invention.

### DETAILED DESCRIPTION

Following are detailed descriptions of specific embodiments of the invention. The scope of the claimed invention is not limited to the described embodiments, but is instead delineated by the claims.

Thumb Mounted Miniature Mouse and Stylus

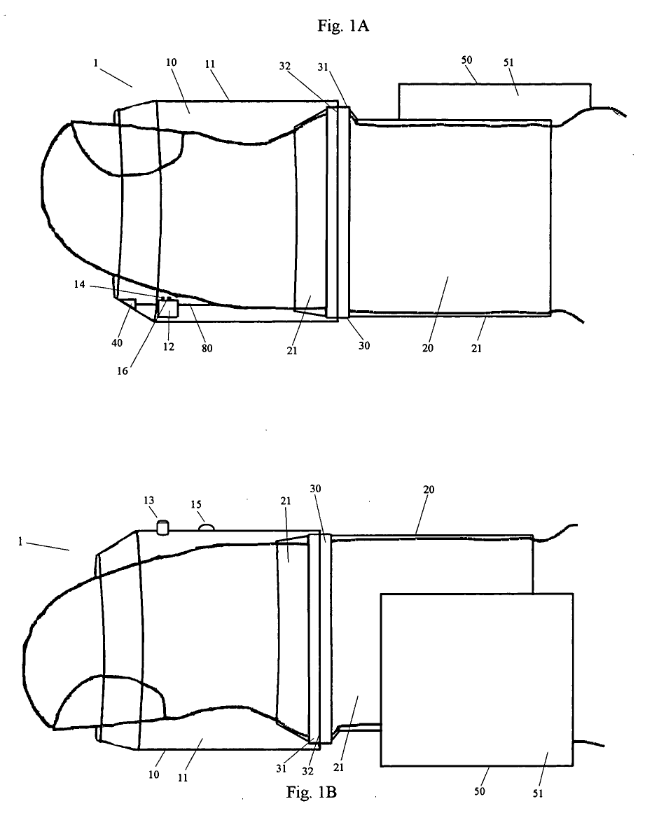

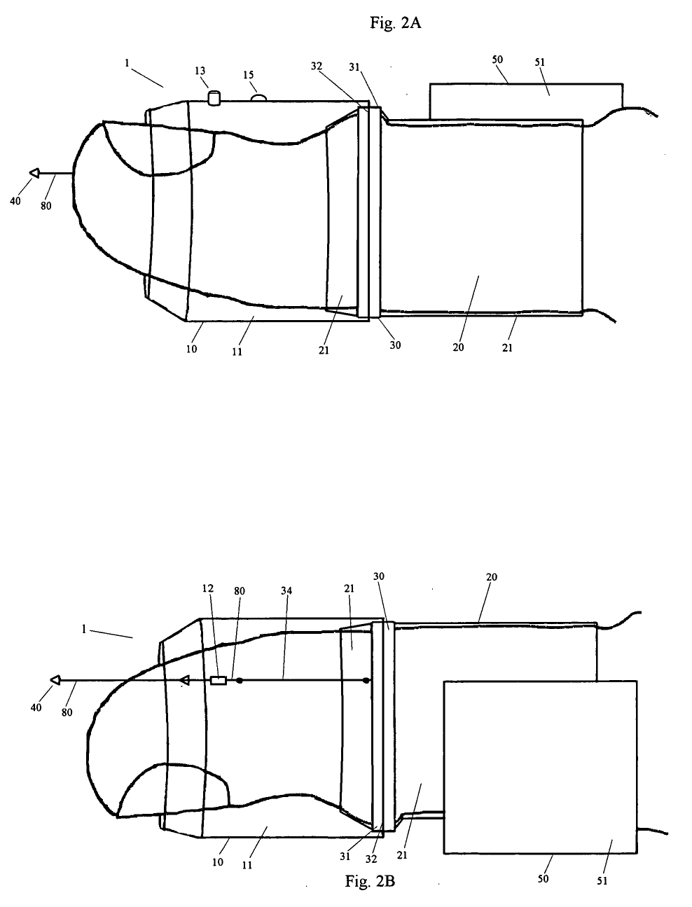

The first embodiment of the present invention is a thumb mounted optical mouse with an included stylus. As shown in FIGS. 1 and 2, thumb mouse 1 is comprised of first mouse section 10, second mouse section 20, bearing 30, optical motion detector 40, remote housing 50, image fiber bundle 60, light source fiber bundle 70, and stylus 80.

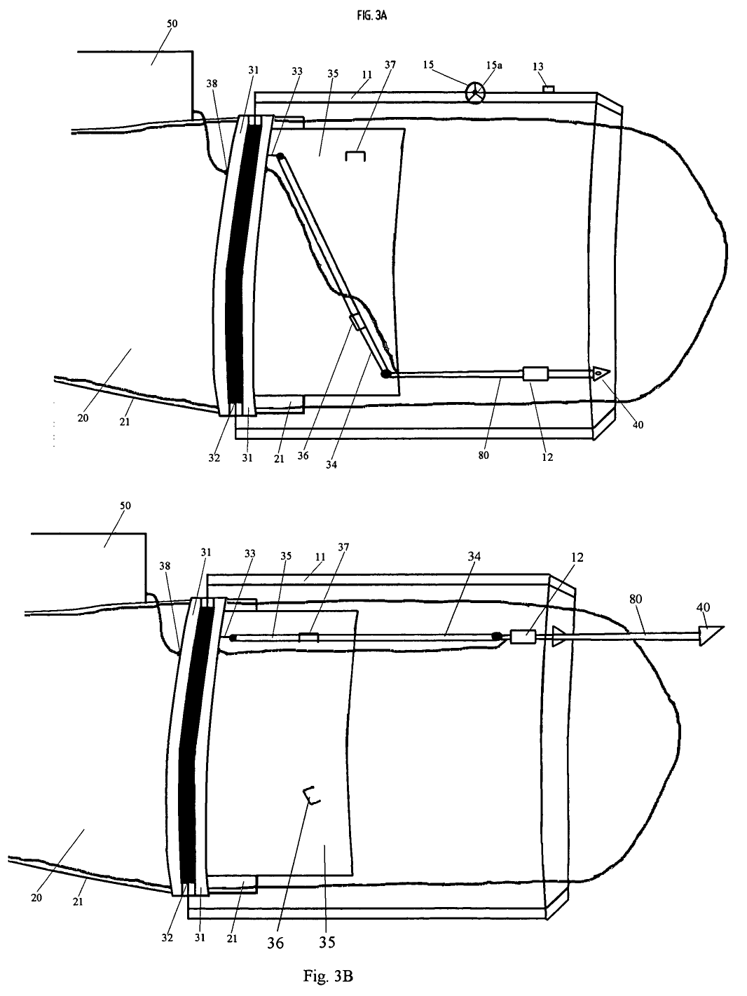

As shown in FIGS. 3A and 3B, first mouse section 10 is comprised of manifold 11, mounting device 12, right mouse button 13, left mouse button 14, wheel 15, wheel button 15a, and pressure sensor 16. Manifold 11 is a hollow substantially rigid cylinder. Mounting device 12 is a rigid bar containing a rectangular opening, which extends through mounting device 12. Mounting device 12 is affixed to the inner surface of manifold 11. Left mouse button 14 and pressure sensor 16 are mounted onto mounting device 12 such that they are positioned between mounting device 12 and a user's thumb. Additionally, first mouse section 10 is configured such that a small space exists between a user's thumb and mounting device 12, unless the two are compressed together. Right mouse button 13 and wheel 15 are mounted onto the outside of manifold 11 approximately 90 degrees in the counterclockwise direction from mounting device 12 with wheel 15 set back towards the rear of the thumb from right mouse button 13.

As shown in FIGS. 1 and 2, second mouse section 20 is comprised of elastic cylinder 21 and remote housing mounting bracket 22. Elastic cylinder 21 fits snuggly onto a user's thumb. It covers the first thumb joint and extends back to the second thumb joint remote housing mounting bracket 22 is secured in elastic cylinder 21. Alternatively, elastic cylinder 21 could be comprised a flexible non elastic material, such as cloth or leather, that is secured to the thumb through the use of velcro or a belt type fastener.

As shown in FIG. 3, bearing 30 is comprised of outer coupling 31, inner coupling 32, joint 33, stylus control arm 34, and guide plate 35. Outer coupling 31 extends from and is mounted to elastic cylinder 21 of second mouse section 20. The radius of outer coupling 31 is greater than the radius of elastic cylinder 21 such that elastic cylinder 21 can expand to fit fingers of varying sizes. Inner coupling 32 is affixed to manifold 11 of first mouse section 10. Additionally, Inner coupling 32 is mounted inside outer coupling 31 such that first mouse section 10 can rotate with respect to second mouse section 20 from a first position (the “mouse position”) to a second position (the “stylus position”). The mouse position is shown in FIG. 1 and FIG. 3A. The stylus position is shown in FIG. 2 and FIG. 3B. Stylus control arm 34 is pivotally mounted to outer coupling 31 by joint 33. Guide plate 35 includes lower snap fitting 36 and upper snap fitting 37. When first mouse section 10 is in the mouse position, stylus control arm 34 is held in place by lower snap fitting 36 and when first mouse section 10 is in the stylus position, stylus control arm 34 is held in place by upper snap fitting 37. Opening 38 is provided in outer coupling 31. The fiber bundles and the various wires that connect to the buttons and sensors hat are mounted in first mouse section 10 are joined together into a cable which passes through opening 38.

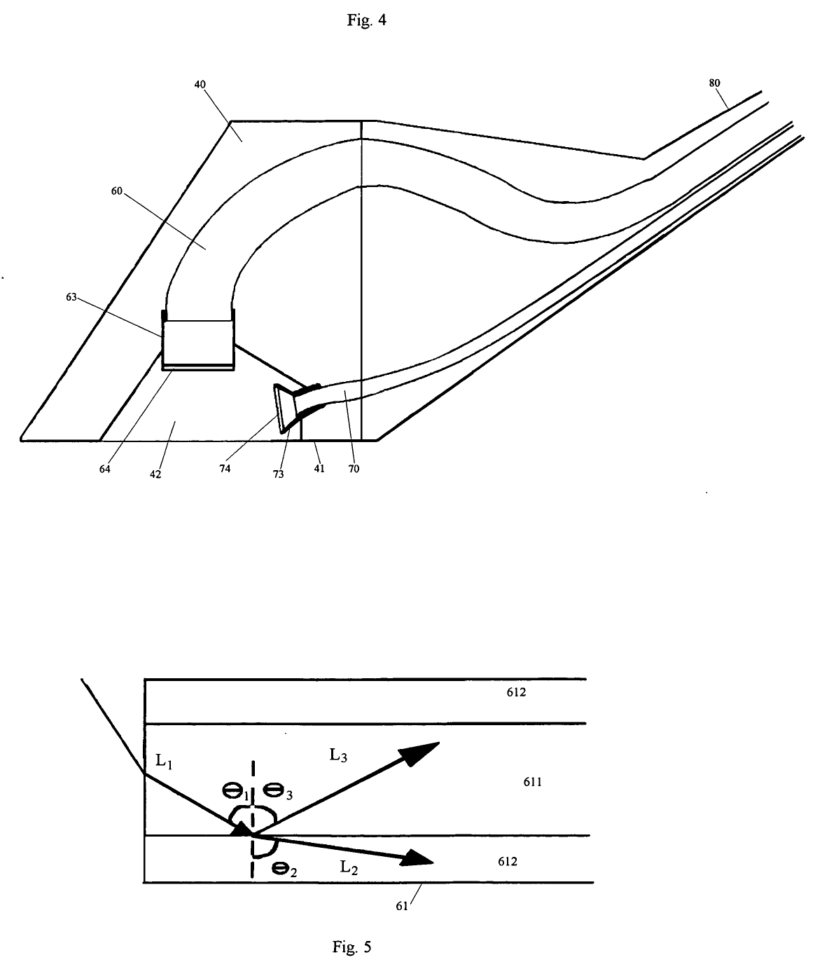

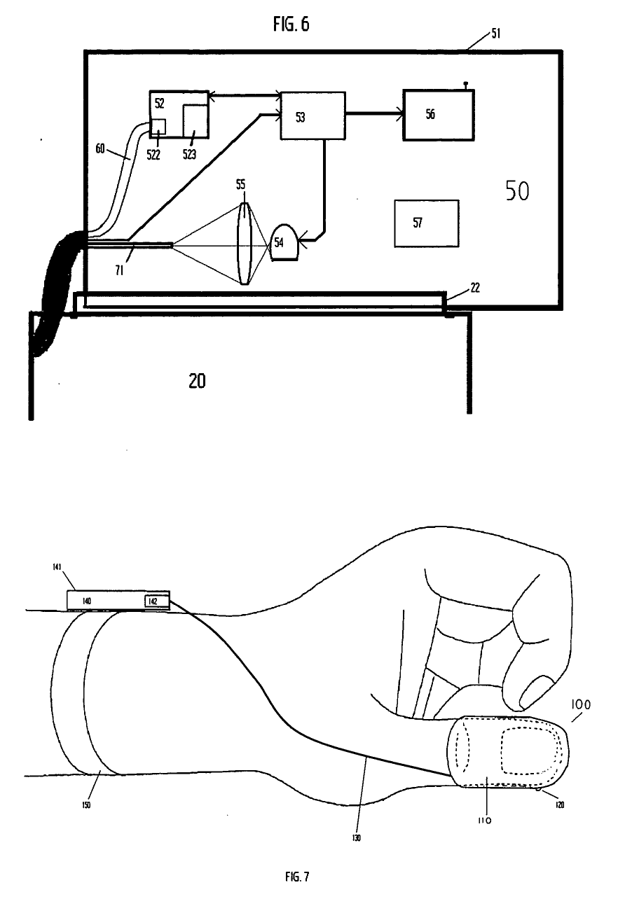

As shown in FIG. 4, optical motion detector 40 is comprised of detector frame 41, opening 42, the distal end of image fiber bundle 60, and the distal end of light source fiber bundle 70. Image fiber bundle 60 comprises a plurality of image fibers 61, (see FIG. 5), image tip 63, and focusing lens 64. Image fibers 61 are flexible fiber optic fibers. Light source fiber bundle 70 comprises a single flexible fiber 71, light tip 73, and collimating lens 74.

Image tip 63 is a hollow rigid cylinder that mounts image fiber bundle 60 to frame 41 and that maintains the positioning of image fibers 61 with respect lens 64. In this embodiment, each fiber 61 is used to transmit one pixel of the image and the relative positioning of the fibers is maintained throughout the length of the fiber bundle.

FIG. 5 shows a portion of an image fiber 61. Fiber core 611 is surrounded by cladding 612. Fiber core 611 has an index of refraction N_{f} that is higher than the index of refraction for the cladding N_{c}. In general, when a light ray L 1′ which is propagating through fiber core 611, is incident upon the boundary between fiber core 611 and cladding 612, some of the light L₂ is transmitted into cladding 612 and some of the light L₃ is reflected back into fiber core 611. According to Snell's Law, the angle of refraction Θ₂, which describes the direction of propagation of the transmitted light L₂ through cladding 612, is dependant upon the angle of incidence Θ₁ of light ray L₁ and the ratio of the fiber core index of refraction N_{f} to the cladding index of refraction N_{c}. Snell's Law can be expressed by the following formula: N_{f} Sin(Θ₁)=N Sin(Θ₂). Additionally, the angle of reflection is equal to the angle of incidence Θ₃=Θ₁. Angles Θ₁, Θ₂, and Θ₃ are all measured with respect to a line normal to the surface of the cladding at the point of interest. If the angle of refraction Θ₂ is greater than or equal to 90 degrees, the entire ray is reflected and no light is transmitted into the cladding. This phenomenon is known as total internal reflection. Accordingly, light with an angle of incidence Θ₁ greater than the inverse sine of the cladding index of refraction N_{c} divided by the fiber core index of refraction N_{f} will be totally internally reflected (Total internal reflection occurs if Θ₁>Invsin(N_{f}/N_{c})) and transmitted through the fiber.

In fiber optics, the term “critical angle” usually refers to the maximum angle that a light ray can have with respect to a line tangent to the core/cladding boundary, which is equal to 90 degrees minus the light ray's angle with the normal, and still be totally internally reflected. Accordingly, light with angles less than the critical angle can be transmitted substantial distances through fiber core 611 with only minimal loses.

As shown if FIG. 6, remote housing 50 is comprised of remote frame 51, motion sensor 52, control processor 53, light source 54, gathering lens 55, transmitter 56, power supply 57, the proximal end of image fiber bundle 60, and the proximal end of light source fiber bundle 70. Motion sensor 52 includes optical sensor array 521, and digital signal processor 522. Remote housing 50 is mounted to second mouse section 20 by housing mounting bracket 22.

In the preferred embodiment, optical sensor array 521 is a 20×20 array of optical sensors. Image fibers 61 are arranged in image fiber bundle 60 such that they form a 20×20 square array and each image fiber 61 is coupled to the corresponding optical detector in optical sensor array 521, where each fiber and each detector correspond to one pixel.

As shown in FIG. 6, Lens 55 gathers light from light source 54 and directs the light onto flexible fiber 71 of light source fiber bundle 70. Flexible fiber 71 transmits the light directed onto it. In order to be transmitted by flexible fiber 71, the light must be totally internally reflected in flexible fiber 71. Accordingly, a light ray incident upon the core of flexible fiber 71 will only be transmitted if the sine of the angle of incidence of the light ray is less than the numerical aperture of flexible fiber 71. The numerical aperture of flexible fiber 71 is dependant upon the index of refraction of the air, the index of refraction of the core of flexible fiber core 71, and the index of refraction of the cladding of flexible fiber 71. The numerical aperture is greater than the cosine of the critical angle, since light is refracted towards the normal when it enters flexible fiber 71. As an alternative to lens 55, a mirror could be positioned behind light source 54 to reflect light from light source 54 into flexible fiber core 711 or a mirror and lens could be used in combination. Additionally, a plurality of flexible fibers 71 could be used instead of a single flexible fiber 71.

Stylus 80 is shown in FIGS. 3A and 3B. Stylus 80 is a plastic bar having a rectangular cross section. It is connected to stylus control arm 34, it passes through the rectangular opening in mounting device 12, and it is connected to motion detector 40. Stylus 80 contains a central opening that houses image fiber bundle 60 and light source fiber bundle 70 as well as electrical conductors. As shown in FIG. 3A, stylus 80 twists in a counterclockwise between mounting device 12 and stylus control arm 34. When thumb mouse 1 is switched from the mouse position to the stylus position, stylus 80 passes through opening 17 and the twist in stylus 80 causes mounting device 12 to apply a torque to stylus 80. The applied torque rotates stylus 80 in a clockwise direction so as to properly position optical motion detector 40 for placement on a surface during stylus operation.

During operation, thumb mouse 1 is worn on a user's thumb. When thumb mouse 1 is in the mouse configuration, as shown in FIG. 1, optical motion detector 40 is positioned near the lower left edge of the thumb's fingertip. Accordingly, motion detector 40 can easily be brought into contact with an external surface, such as the flat surface located adjacent to the spacebar in most keyboards, while a user's fingers remain in a normal typing position. When optical motion detector 40 is brought into contact with an external surface, the user's thumb presses into pressure sensor 16, which provides an electrical signal to control processor 53. Control processor 53 energizes light source 54, which provides light to light source fiber bundle 70 through gathering lens 55. The light is transmitted through flexible fiber 71, which emits a cone of light to collimating lens 74. Collimating lens 74 collimates the light into parallel rays and it directs the light rays at a low angle onto a target area of the surface located below focusing lens 64. Light is reflected from features on the surface to focusing lens 64.

Focusing lens 64 focuses the light reflected from the surface onto image fibers 61. Each image fiber 61 transmits one pixel of the image to a corresponding optical sensor in optical sensor array 521, which generates an analog electrical output that correspond to the light intensity of the pixel. The analog output of each optical sensor is converted into digital representations of the pixel. The digital representations of the pixels are stored in memory. Digital signal processor 522 uses well known techniques to mathematically determine the motion of optical motion detector 40 with respect to a surface by comparing a sample area of a current image to shifted versions of a prior image. Examples of such techniques are described in U.S. Pat. No. 6,151,015 and U.S. Pat. No. 6,664,948. Signals representative of the motion are provided to control processor 53.

While a user's fingers are positioned for typing on a keyboard, the user operates left mouse button 14 by pressing first mouse section 10 into the surface causing the thumb to press against left mouse button 14, which is located on mounting device 12. Right mouse button 13 is operated by repositioning the thumb and pressing right button 13 against the edge of the keyboard. Likewise, wheel 15 is operated by rolling it along the edge of the keyboard to generate a signal from its transducer or by pushing the wheel into the edge of the keyboard to operate wheel button 15a. Right mouse button 13, left mouse button 14, wheel 15, and wheel button 15a provide signals to control processor 53 via wires.

Control processor 53 processes the signals that it receives and it generates mouse output signals, which it provides to transmitter 56. Transmitter 56 transmits modulated mouse output signals to a receiver that is connected to or integrated with a computer, PDA, or other similar device with an appropriate driver.

While in the mouse configuration, thumb mouse 1 can be used in a manner similar to an ordinary mouse. The edge of the user's thumb including motion detector 40 is positioned onto to a relatively flat surface such as a table or the user's pants. The user's right index finger is positioned onto the opposing side of the thumb in front of first mouse section 10, and the user's middle finger is positioned onto right mouse button 13. Pointer motion is accomplished by moving the thumb along the surface in the same manner as the user would move an ordinary mouse. Left mouse button 14 operation is accomplished by the user pressing her index finger into her thumb causing the thumb to press down into left mouse button 14. Accordingly, the user can perform “clicking” or “double clicking” by pressing down with her left index finger just as she would with a standard mouse. Right mouse button 13 and wheel 15 are operated with the user's middle finger.

Thumb mouse 1 is switched from the mouse configuration to the stylus configuration by rotating first mouse section 10 in a counterclockwise direction with respect to second mouse section 20. Mounting device 12 applies a force to stylus 80 in the direction of first mouse section 10's rotation. This force is coupled to stylus control arm 34, which disengages from lower snap fitting 36, and moves in conjunction with stylus 80. The angle between stylus 80 and stylus control arm 34 is reduced and stylus 80 is pushed outward through opening 17 in mounting device 12. The counterclockwise twist in stylus 80 causes a torque to be applied to stylus 80 by mounting device 12. The applied torque rotates stylus 80 in a clockwise direction such that optical motion detector 40 is properly aligned for positioning on a surface. Upon completion of the rotation, stylus control arm 34 is positioned in upper snap fitting 37 and stylus 80 is extended out from first mouse section 10. Alternatively, stylus 80 could be extended and rotated through the use of gears or pinions.

During stylus operation, thumb mouse 1 will normally, although not necessarily, be used with drawing software or with software for converting handwriting into text. A user will use her index finger to press stylus 80 towards the user's thumb, which will tilt first mouse section 10 causing pressure sensor 16 and left mouse button 14 to contact the user's thumb. Light pressure against pressure sensor 16 will cause light source 54 to energize. The user then positions her hand such that optical motion detector 40 is positioned on a surface. Movement of optical motion detector 40 along the surface will cause the cursor to move in the applicable display device. Pressing harder against stylus 80 will cause left mouse button 14 to switch on and the movement of optical motion detector 40 will then cause a corresponding line or curve to be drawn on the applicable display device.

An additional sensor can be included in thumb mouse 1 to detect whether it is in the mouse configuration or the stylus configuration. The functions performed by the mouse buttons and wheel can then be automatically changed to perform drawing functions while thumb mouse 1 is in the stylus configuration. For example, pressure sensor 16 could be used to control the thickness of the line drawn on the screen or wheel 15 could be used to vary the ratio of movement of optical detector 40 to the length of the displayed line. Additionally, the rate of change of the output of pressure sensor 16 can be monitored such that an applied pressure pulse when left mouse button 14 is already pressed can cause a function, such as switching from writing to erasing, to be performed.

Another function that can be performed when thumb mouse 1 is in the stylus mode is the insertion of a figure into the body of an email or word processing document. As discussed above, a sensor can be used to detect thumb mouse 1's being configured in the stylus mode. Additionally, the associated computer can be programmed such that the right mouse button can be used to indicate that an image box is to be placed in the email body or word processing document when the right mouse button is pressed while the thumb mouse is in the stylus mode. The user then positions the cursor and left clicks on two opposing corners of where the image box should be positioned. The software then places an image box in the location specified by the two corners and the user can draw an image within the box.

Thumb mouse 1 could be manufactured in a variety of sizes and it could be configured for use on the left thumb instead of the right thumb. Additionally, motion detector 52 or a stand alone optical sensor array could be placed in optical motion detector 40 instead of using image fiber bundle 60, since IC chips containing motion detectors or optical sensor arrays can be made quite small. Further, remote housing 50 could be mounted on a user's wrist instead of onto second mouse section 20.

Retractable Fingertip Mouse

A second embodiment of the present invention is shown in FIGS. 7-9. As shown in FIG. 7, retractable fingertip mouse 100 is comprised of fingertip covering 110, motion detector 120, cable 130, housing 140, and wristband 150. Fingertip covering 110 is made from an elastic flexible cloth like material. Cable 130 passes through fingertip covering 110 and into motion detector 120, which is mounted in fingertip covering 110.

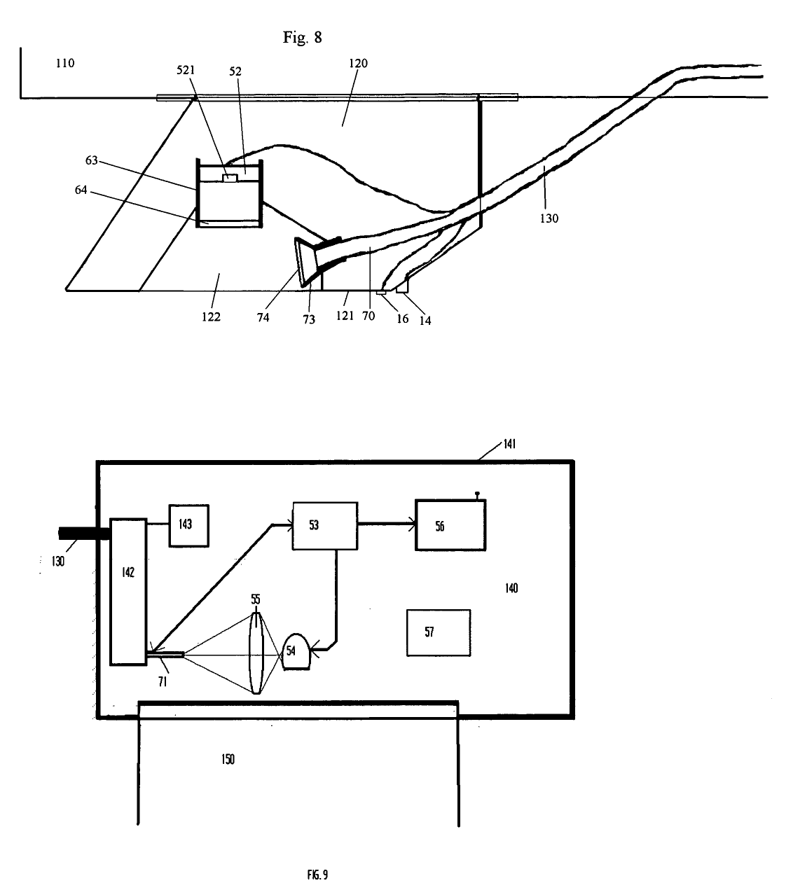

As shown in FIG. 8, motion detector 120 is comprised of rigid frame 121, pressure sensor 16, left mouse button 14, motion sensor 52, focusing lens 64, and the distal end of light source fiber bundle 70. Cable 130 comprises light source fiber bundle 70 and a protective covering as well as the electrical conductors for pressure sensor 16, left mouse button 14, and motion sensor 52.

As shown in FIG. 9, housing 140 comprises housing frame 141, spool 142, spring assembly 143, control processor 53, light source 54, gathering lens 55, transmitter 56, power supply 57, and the proximal end of light source fiber bundle 70. Housing 140 is mounted onto wristband 150, which is similar to a watchband. Housing 140 may contain a compartment for housing fingertip covering 110.

Housing 140, or the components contained therein with the exception of housing frame 141, could be contained in a laptop computer, PDA, portable keyboard, or other similar device instead of on a user's wrist. Some of the components such as power supply 57 or control processor 53 could be shared with the other device. Additionally, transmitter 56 would not be necessary if the housing was contained in a laptop or PDA. Further, a portable keyboard could share a transmitter or other interfaces with fingertip mouse 100.

When retractable fingertip mouse 100 is not in use, fingertip covering 110 is positioned next to housing 140 and cable 130 is wound onto spool 142. For use, fingertip housing 110 is pulled onto a finger or thumb causing cable 130 to unwind from spool 142, which compresses the spring in spring assembly 143. When motion detector 120 is lightly pressed against a surface, pressure sensor 16 causes light source 54 to energize. Light source 54 provides light to light source fiber bundle 70 through gathering lens 55. The light is transmitted through flexible fiber 71, which emits a cone of light to collimating lens 74. Collimating lens 74 collimates the light into parallel rays and it directs the light rays at a low angle onto a target area of the surface located below motion detector 120. Focusing lens 64 focuses an image of the surface onto optical sensor array 521. Fingertip motion is detected and translated into pointer control signals as described above for the first embodiment. The application of additional downward pressure by the fingertip onto motion detector 120 causes left mouse button 14 to operate. When fingertip covering 130 is retracted, the energy contained in the compressed spring is used to wind cable 130 onto spool 142.

A stylus can be added to retractable fingertip mouse 100. Motion detector 120 would be mounted on the end of the stylus. The stylus would be slidably mounted in fingertip covering 110 and it would include a finger tab such that it could be extended out from fingertip covering 110. Additionally, wheel 15 and wheel switch 15a could be mounted in fingertip covering 110 through the use of a rigid mounting structure and right mouse button 13 could also be mounted in fingertip covering 110.

In order to preserve battery power, external or ambient light can be used as an alternate light source to light source 54. For example, the upper surface of housing frame 141 could be replaced by or provided with a lens that collects ambient light and directs it onto flexible fiber 71. Those of skill in the art will appreciate that mirrors, waveguides, or lenses, including gathering lens 55, can be used to assist in focusing the light onto flexible fiber 71. A switch can be provided for the user to select the ambient light mode.

Glove Mouse

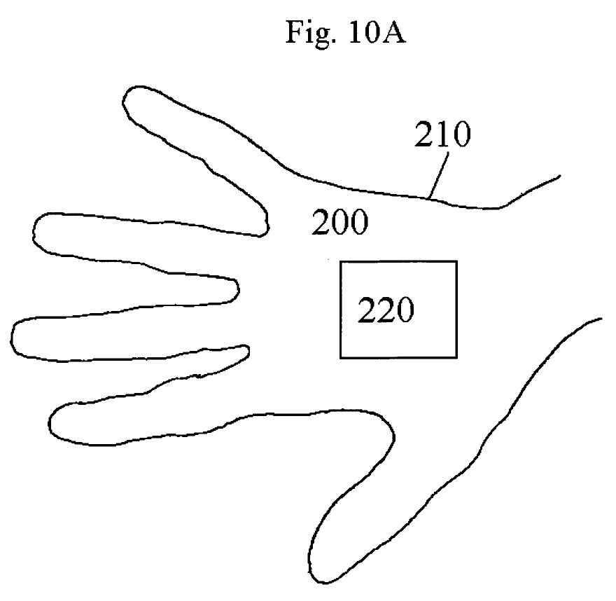

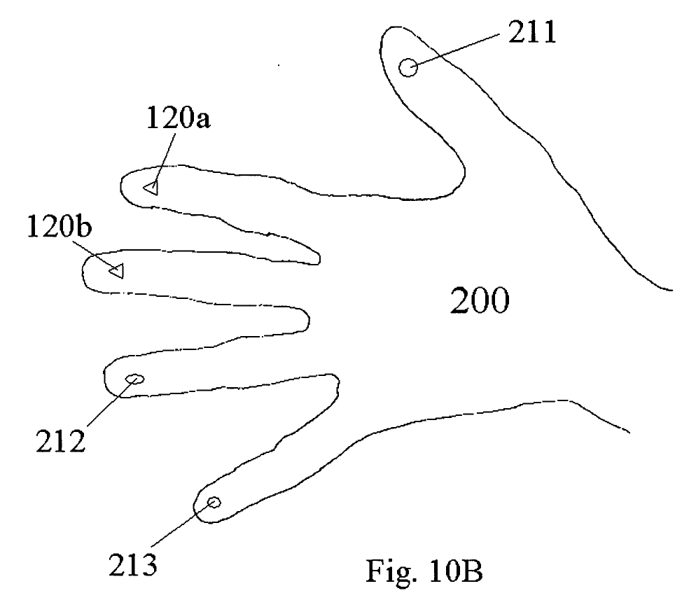

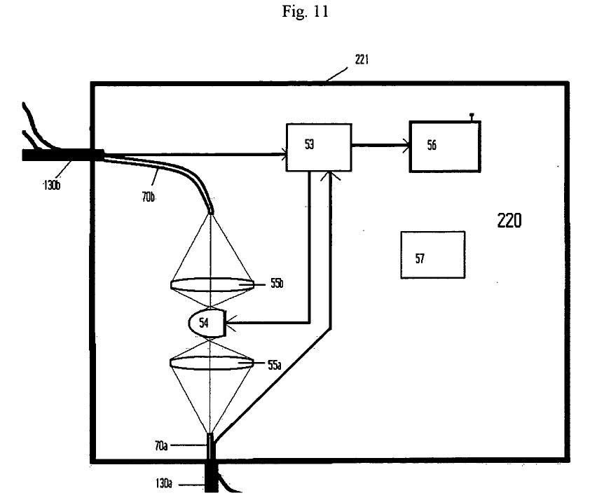

A third embodiment of the present invention is shown in FIGS. 10A, 10B, and 11. Glove mouse 200 is comprised of glove body 210, thumb switch 211, ring finger switch 212, pinky switch 213, left motion detector 120a, right motion detector 120b, left cable 130a, right cable 130b, and glove mounted housing 220.

Left and right motion detectors 120a and 120b are substantially the same as motion detector 120 of the previous embodiment. The components comprising left and right motion detectors 120a and 120b are numbered the same as those for motion detector 120 except that the suffix ‘a’ or ‘b’ is added as appropriate. Additionally, motion detectors 120a or 120b could be provided with a retractable stylus.

Left cable 130a and right cable 130b are substantially the same as cable 130 from the previous embodiment, except that left cable 130a joins with a wire from thumb switch 211 and right cable 130b joins with wires from ring finger switch 212 and pinky switch 213.

Glove body 210 is made from a dual layer comfortable close fitting cloth material. Thumb switch 211, ring finger switch 212, pinky switch 213, left motion detector 120a, right motion detector 120b, left cable 130a, right cable 130b, and glove mounted housing 220 are mounted in glove body 210. Left cable 130a and right cable 130b are positioned between the two layers of glove body 210.

As shown in FIG. 11, glove mounted housing 220 comprises frame 221, control processor 53, light source 54, left gathering lens 55a, right gathering lens 55b, transmitter 56, power supply 57, the proximal end of left light source fiber bundle 70a, and the proximal end of right light source fiber bundle 70b. Light source 54 provides light for both left motion detector 120a and right motion detector 120b. However, control processor 53 does not enable processing of images from left motion detector 120a (right motion detector 120b) unless it receives a signal from left pressure sensor 16a (right pressure sensor 16b).

In the preferred embodiment, left motion detector 120a is used for both cursor control and left mouse button functions, while right motion detector 120b is used for both scrolling and scrolling button functions. Although a one dimensional sensor, such as a wheel, could be used to provide the scrolling function, the use of a two dimensional motion sensor, allows right motion detector 120b to provide additional functions. For example, right motion detector 120b could be used to provide a horizontal scrolling function as well as a vertical scrolling function. Alternatively, the extra dimension could be used to provide a magnification function to simulate close up or far off viewing.

Thumb switch 211, ring finger switch 212, and pinky switch 213 are small switches that are sewn into the finger tip areas of the glove for the applicable fingers. The switches close when the applicable finger is pressed onto a surface causing a signal to be sent through a wire to control processor 53. In the preferred embodiment, thumb switch 211 performs the “Ctrl” function, ring finger switch 212 performs the right mouse button function, and pinky switch 213 performs the “return” function. Accordingly, glove mouse 200 is quite convenient for use with the internet. For example, when working with a list of selectable items, a user can use their thumb to institute the “ctrl” function, their middle finger to scroll through the list, their index finger to make multiple selections, and their pinky to enter the selections.

Software can be provided in control processor 53 and the applicable driver to allow the functions performed by thumb switch 211, left mouse button 14, wheel button 15a, ring finger switch 212, and pinky switch 213 to be altered to provide a variety of keyboard and mouse functions according to a user's preference. Additionally, depending upon the device for which the glove mouse is providing cursor control, the switches could be used to perform miscellaneous functions such as to initiate internet log on or to accept an incoming call.

Monitor Compatible Mouse

Another aspect of the present invention is an optical mouse that can be used on the viewing surface of a computer monitor. This aspect of the invention can be implemented in each of the previously described embodiments.

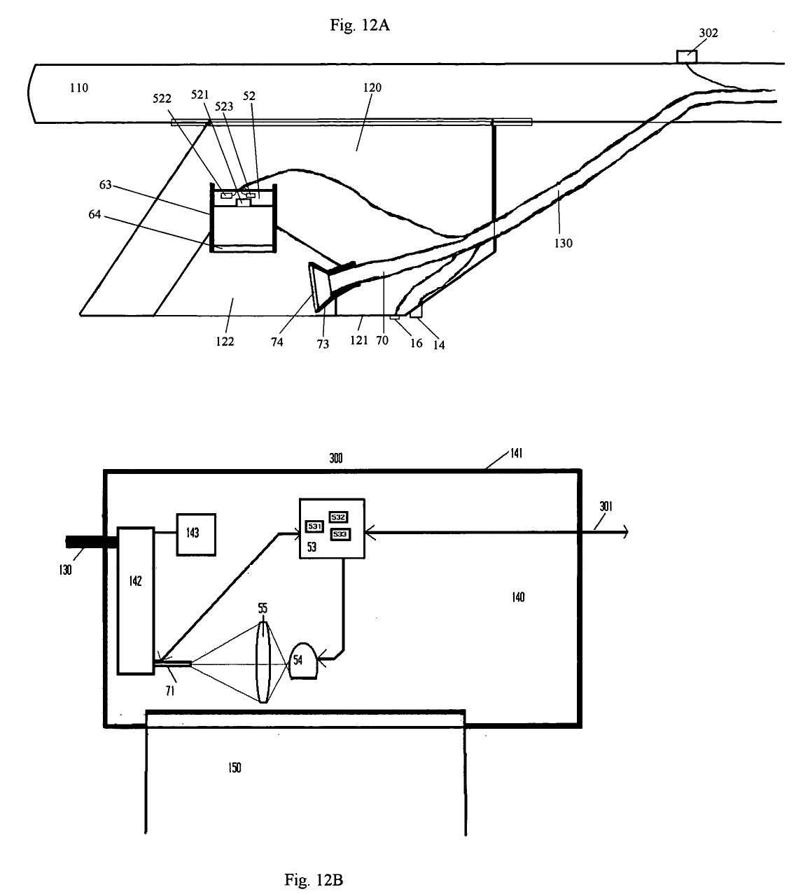

The fourth embodiment of the present invention is shown in FIG. 12. Screen mouse 300 includes all of the components of retractable fingertip mouse 100, except that it does not have a transmitter 56 or a power supply 57. Additionally, screen mouse 300 includes cable 301 for connection to a computer with a CRT monitor and it includes screen switch 302, which is located on the opposite side of fingertip covering 110 from motion detector 120. Further, motion sensor 52 includes analog output circuit 523 and control processor 53 includes pulse detector 531, vertical timer 532, and horizontal timer 533. Vertical timer 532 and horizontal timer 533 can be implemented as programs in processor 53.

The cursor control signals and mouse button output from control processor 53 are provided to a computer via cable 301 and electrical power is provided to screen mouse 300 via cable 301. Additionally, cable 301 provides vertical and horizontal synch signals to control processor 53.

Vertical and horizontal sync signals are contained in the video signals sent to the CRT monitor. These signals control the beginning of the vertical and horizontal sweeping of the electron gun. The electron gun sweeps a ray of electrons across an array of phosphor pixels on the inside surface of the computer screen causing light to be emitted. The vertical synch signal marks the beginning of the sweep. After a vertical retrace period, the horizontal synch signal marks the beginning of a sweep across a horizontal row. The rows are swept in sequence either from bottom to top or top to bottom, although rows may be skipped in a sweep. For example, even rows may be swept in one vertical sweep and odd rows in the next. Accordingly, the vertical position of the electron beam on the screen and of the light being generated thereby is determinable from the time since the last vertical synch pulse. Likewise, the horizontal position of the electron beam on the screen and of the light being generated thereby is determinable from the time since the last horizontal synch pulse.

As shown in FIG. 12, motion sensor 52 includes optical sensor array 521, digital signal processor 522, and analog output circuit 523. When a user places screen switch 302 in its “on screen” position, screen mouse 300 is placed in the screen mode and the outputs of the sensors in optical sensor array 521 are provided to analog output circuit 523. Analog output circuit 523 sums the outputs of the individual sensors, amplifies them, and outputs them to pulse detector 531 in control processor 53. Pulse detector 531 includes an input high pass filter and an output flip flop type device.

Additionally, when screen mouse 300 is in the on screen mode, control processor 53 provides a signal to the mouse driver in the attached computer, that causes the mouse driver to switch to its on screen mode. The mouse driver provides the vertical and horizontal synch signals from the computer's video processor to control processor 53 via cable 301. Upon receipt of a vertical synch signal, control processor 53 causes vertical timer 532 to reset and to begin timing and it sets the output of pulse detector 531's flip flop device to a digital “zero”. Between each vertical synch signal many horizontal synch signals are provided to control processor 53 and to the CRT monitor. As long as the output of pulse detector 531 is set to a digital “zero”, each horizontal synch signal causes horizontal timer 533 to reset and to begin timing.

When motion detector 120 is pressed against the viewing surface of the CRT monitor, pressure sensor 16 provides a signal to control processor 53, which enables pulse detector 531 to detect pulses from analog output circuit 523. Focusing lens 64 is capable of receiving light from those pixels on the CRT surface that are within a given target radius of the point directly below the center of focusing lens 64. When a horizontal sweep occurs across a row that is within the target radius of focusing lens 54, light will be provided to the optical sensors in sensor array 521 causing a pulse to be generated by analog output circuit 523. If sufficient light reaches sensor array 521, then the generated pulse will be of sufficient magnitude to switch the output of pulse detector 531 to a digital “1”.

When the output of pulse detector 531 is a digital “1”, Vertical timer 532 and horizontal timer 533 stop counting. Control processor 53 outputs digital signals representative of the amount of time measured by vertical timer 532 and horizontal timer 533 to the computer. The mouse driver in the computer utilizes the output from vertical timer 532 to calculate the vertical position (y coordinate) of motion detector 120 and it utilizes the output from horizontal timer 533 to calculate the horizontal position (x coordinate) of motion detector 120. The computer's video processor can then place the pointer at the corresponding location on the monitor's viewing surface. Pressing left mouse button 14 will position the cursor at the pointer location. The positioning of the pointer can be fine tuned with a calibration process.

In some cases, the output pulse from analog output circuit 523 may not be of sufficient magnitude to cause pulse detector 531 to output a digital “1”. This may occur if the horizontal line being swept is on the periphery of the target area or if the horizontal line contains a large number of dark pixels, which may occur if motion detector 120 is positioned in a dark area of the image. However, sensor array 521 will continue to detect light from the passage of the electron beam for several more rows, if necessary, until a pulse is detected. In rare instances, if motion detector 120 is positioned in a large very dark area of the screen, no pulse will be detected and the cursor will not be positioned until motion detector 120 is moved to another location. However, cursor positioning into such areas is not required by most computer applications and, if necessary, screen switch 302 can be pressed and screen mouse 300 can be used as an ordinary optical mouse to position the cursor in the dark area.

Other monitors, such as LCD monitors and Plasma monitors do not utilize electron guns to sequentially illuminate pixels on a screen. Accordingly, there is no inherent time ordered light signal traversing the viewing surface of such monitors. However, a time ordered light signal can be imposed on the viewing surface of various types of monitors including LCD and plasma monitors. Such time ordered light signals can be used to determine the position of a mouse or stylus on the monitor's surface.

LCD monitors utilize liquid crystals that twist or change their configuration when an electric field is applied. A typical LCD monitor utilizes pixels that are comprised of twisted liquid crystals sandwiched between two polarizing plates of glass. The amount of externally applied light that will pass through the second polarizing plate and illuminate the pixel is dependant upon the magnitude of an applied voltage with the maximum amount of light passing through when zero voltage is applied and the liquid crystals are fully twisted. A color pixel is generally comprised of three sub pixels each having a color filter. Thin film MOSFET transistors, which are etched onto a glass substrate, are often employed to apply the voltage and thereby control the illumination of each pixel. The pixels are arranged into horizontal lines and vertical columns. The pixels are generally scanned by applying a gate signal, which corresponds to horizontal sync signal, to a horizontal line and then sequentially applying a voltage to each of the vertical columns thereby applying a charge to each of the pixels in that line. The pixel retains the charge until it is scanned again.

A time ordered light signal can be generated on the viewing surface of an LCD monitor by controlling the charge applied to groups of individual pixels in a time ordered manner. The time ordered light signal comprises an mXn array of pixels that moves sequentially across the monitor, a vertical synch signal, and a plurality of horizontal synch signals. The pixels in an LCD display are organized into rows, where each row is comprised of m horizontal lines. The m×n array traverses the monitor one row at a time. The horizontal and vertical synch signals are distinct from the sync signals contained in the video signal and they are generated by a processor in the monitor. The generated synch signals are used to control the time ordered light signal and they are also sent to the computer via data lines in the VGA cable. The charges for the time ordered light signal are applied in much the same manner as they are for the video signal, except that the horizontal synch signal gates all m lines that comprise an entire row. The same conductors as are used for gating and for applying the charge are used for the video signal. However, additional hardware may be necessary to disable normal video image scanning for the lines comprising a row while the time ordered signal is traversing the row as well as to place the voltage on the vertical columns and to provide the row gating signals.

A vertical synch signal marks the beginning of the time ordered light signal's traversal across the monitor's surface. Each horizontal synch signal marks the beginning of the light signal's traversal across an individual row. All of the pixels in a row will remain gated until the light signal has completed traversing the row. After completion of a row, another horizontal synch signal marks the beginning of the light signal's traversal across the next row. After all rows have been scanned, a vertical synch signal will mark the beginning of the next light signal's traversal. The moving pixel array is m pixels in vertical height and n pixels in horizontal width and it comprises p segments, each of which are m pixels in vertical height. Each segment is comprised entirely of pixels that emit maximum light (minimum applied charge) or entirely of pixels that emit minimum light (maximum applied charge). The time ordered light signal progresses across horizontal rows of the viewing surface of the monitor by shifting one column at a time in accordance with a timing signal, where each column is one pixel wide and m pixels thick. After the completion of a row and in conjunction with a horizontal synch signal, the time ordered light signal shifts vertically by m pixels and scans across the next row until the entire screen is traversed. After the completion of the last row and in conjunction with a vertical sync signal, the time ordered light signal shifts back to the first row, which it scans after receiving a horizontal synch signal.

For example, the time ordered light signal could be comprised of three segments that are each eight pixels thick by thirty-two pixels long. In the first segment all pixels are set to provide minimum light; in the second segment all pixels are set to provide maximum light, and in the third segment all pixels are set to provide minimum light. A horizontal sweep commences by overwriting the pixels in the first eight pixel thick column with maximum charge, so as to provide minimum light. At the next time interval, the pixels in the second column are overwritten with maximum charge. This process continues for thirty two time intervals until the pixels in the first thirty-two columns are overwritten with maximum charge. On the thirty-third time interval, the pixels in the thirty-third column are overwritten with maximum charge and the pixels in the first column are overwritten with zero charge. Likewise, on the sixty-fifth time interval, the sixty fifth column and the first column are overwritten with maximum charge while the thirty-third column is overwritten with minimum charge. On the ninety-seventh time interval, the pixels in the ninety seventh and thirty-third columns are overwritten with maximum charge and the pixels in the sixty-seventh column are overwritten with minimum charge, however, the pixels in first column are retained at maximum charge until the entire row has been swept. In this manner, the time ordered light signal progresses horizontally across an eight pixel thick row. Once a row has been completed, the time ordered light signal shifts down eight pixels and it sweeps across the next eight pixel thick horizontal row.

Because of the relatively slow response time of liquid crystals, a time ordered light signal cannot be imposed on the viewing surface of an LCD monitor without noticeably affecting the image. Accordingly, in an LCD monitor, the time ordered light signal will only be imposed on the monitor's viewing surface when screen switch 302 is in the “on screen position” and pressure sensor 16 indicates that motion detector 120 has been pressed against the surface of the monitor. Scanning is commenced by the user placing her finger (motion detector 120) at the location on the monitor's viewing surface where the user would like the pointer to be positioned. A signal is provided from control processor 53 to the monitor via the associated computer. The monitor then generates the time ordered light signal, including the vertical and horizontal sync signals, which it provides to control processor 53 via the associated computer.

Additionally, the slow response time of LCDs may prevent the pixels in the time ordered light signal from achieving their maximum or minimum light values. However, a light pulse can still be generated even if the liquid crystals do not have time to fully respond, provided that care is taken in selecting the traversal speed of the time ordered light signal. Various methods have been suggested for improving the response time LCDs. For example published U.S. Patent Application 20040017343, which is incorporated herein by reference, discloses applying an over-voltage to improve response time when an increased charge is being applied to a pixel. Additionally, a negative (opposite voltage) could be applied to increase response time when a minimum charge (maximum light) signal is being applied to a pixel that was previously at maximum charge. Further, as disclosed in U.S. Patent Application 20040131798, which is incorporated herein by reference, the use of ferroelectric liquid crystals can improve the response time an LCD monitor by a factor of 1000.

As shown in FIG. 12, the vertical sync signal, which is generated by the monitor, is provided to control processor 53 of monitor mouse 300. The vertical sync signal causes vertical timer 532 to reset and to begin timing and it causes the output of pulse detector 531 to be set to a digital “zero”. The computer's video processor also provides control processor 53 with horizontal sync signals that corresponds to the commencement of each horizontal sweep. Each horizontal sync signal causes horizontal timer 533 to reset and to begin timing. When the time ordered light signal passes under the target area of motion detector 120, analog output circuit 523 provides a corresponding electrical signal to pulse detector 531. The high light signal, which is sandwiched between two low light signals, simulates the signal provided by a CRT monitor and the output of pulse detector 531 is changed to a digital “one”. A signal is provided to the computer and the cursor position is calculated as described above for CRT monitors.

Plasma monitors are comprised of pixels that each generate their own light. Each pixel is comprised of red, green, and blue phosphors as well as a gas in its plasma state that generates ultraviolet light while the pixel is turned on. The ultraviolet light causes the phosphors to emit light. The amount of light generated by the pixels is controlled by the amount of time that a given pixel is turned on during a frame. Generally, each pixel has a 256 level grey scale. Accordingly each frame is comprised of eight sub-frames with relative sustaining periods of 128, 64, 32, 16, 8, 4, 2, and 1. Since individuals pixels are turned on and off for the sustaining periods of the appropriate sub-frames, it can be difficult to impose a time ordered light signal on the viewing surface of a plasma monitor that is distinguishable from the light pulses inherent in a plasma monitor. However, one method of doing so, is to impose a time ordered light signal in a manner similar to that described above for LCD monitors, except that the signal should consist of a plurality of precisely timed light pulses that comprise a digital signal that is distinct from the ordinarily occurring light pulses. For example, the imposed digital signal could comprise four pulses alternating between maximum light pulses and minimum light pulses where each pulse takes a relative period of 48 to pass underneath motion detector 120. Hence, monitor mouse 300 can be used with virtually any monitor including, but not limited to, CRT, LCD, or plasma monitors.

I claim:

1. A cursor control device comprising:
a motion detector, which can be pressed against a surface;
an optical sensor array; and
a light source;
wherein said light source is located remotely from said motion detector.

2. The cursor control device of claim 1 wherein:
said optical detector array is located remotely from said motion detector.

3. The cursor control device of claim 1 further comprising:
a stylus.

4. The cursor control device of claim 3 further comprising:
a mouse body.

5. The cursor control device of claim 4 wherein:
said motion detector is mounted on said stylus;
said stylus is mounted in said mouse body; and
said stylus is extendable from said mouse body.

6. The cursor control device of claim 5 wherein
said stylus extends from said mouse body when said mouse body is rotated.

7. The cursor control device of claim 1 further comprising:
a means for mounting said motion detector on a user's finger.

8. The cursor control device of claim 1 wherein:
said light source is ambient light.

9. A cursor control device comprising:
an optical sensor array;
a light source; and
an optical fiber.

10. The cursor control device of claim 9 further comprising:
a plurality of motion detectors.

11. The cursor control device of claim 9 further comprising:
a glove having a plurality of finger coverings.

12. The cursor control device of claim 11 further comprising:
a plurality of switches mounted in said finger coverings.

13. A method of determining a position associated with an object placed over a viewing surface of a monitor comprising the step of:
detecting a time ordered signal, which is traversing the viewing surface of the monitor; and
determining the position of said object based upon when said time ordered signal was detected.

14. The method of claim 13 further comprising the step of:
positioning a pointer in the vicinity of said position.

15. The method of claim 13 further comprising the step of:
inserting said time ordered signal onto the viewing surface of said monitor.

16. A device for determining the position of an object on the viewing surface of a monitor comprising:
an optical sensor;
a horizontal timer; and
a vertical timer.

17. A device for detecting a position associated with an object placed in the vicinity of a monitor comprising:
a means for detecting a time ordered light signal.

18. The device of claim 17 further comprising:
a means for detecting motion across a surface.
